(19) United States
(12) Patent Application Publication
(10) Pub. No.: US 2026/0194019 A1
(43) Pub. Date: Jul. 9, 2026

(54) FUEL OIL SUPPLY DEVICE

(71) Applicant: MITSUBISHI HEAVY INDUSTRIES, LTD, Tokyo (JP)

(72) Inventors: Rei IKEDA, Tokyo (JP); Masahiko NAKAHARA, Tokyo (JP)

(21) Appl. No.: 19/131,340

(22) PCT Filed: Nov. 28, 2023
(86) PCT No.: PCT/JP2023/042504

§ 371 Date: May 20, 2025

(30) Foreign Application Priority Data
Dec. 19, 2022 (JP) 2022-201808

(51) Int. Cl. F02C 9/32; F02C 3/24; F02C 3/30; F02C 7/232

(52) U.S. Cl. CPC F02C 9/32; F02C 3/24; F02C 3/30; F02C 7/232

(57) ABSTRACT

The present disclosure relates to a fuel oil supply device for supplying fuel oil to a combustor of a gas turbine. The fuel oil supply device is provided with: a pump for supplying fuel oil; a supply pressure control valve disposed downstream of the pump and used for controlling the pressure of the fuel oil supplied by the pump; and a plurality of flow rate controlling valves disposed downstream of the supply pressure regulating valve and used for controlling the flow rates of the fuel oil supplied to a plurality of fuel nozzles provided in a combustor. Further, a plurality of cavitation suppressing parts are provided downstream of the plurality of flow rate controlling valves. The openings of the flow rate regulating valves are controlled on the basis of the first pressure of the fuel oil upstream of the flow rate controlling valves, the second pressure of the fuel oil downstream of the flow rate controlling valves, and the flow rates of the fuel oil supplied to the fuel nozzles.

### TECHNICAL FIELD

The present disclosure relates to a fuel oil supply device for supplying a fuel oil to a combustor of a gas turbine.

The present application claims priority based on Japanese Patent Application No. 2022-201808 filed in Japan on Dec. 19, 2022, the contents of which are incorporated herein by reference.

### BACKGROUND ART

In a gas turbine, a turbine is driven by a combustion gas generated by combusting a fuel in a combustor. In a typical gas turbine, a fuel gas operation in which a fuel gas is mainly used as a fuel is performed, but there is also a gas turbine capable of performing an oil firing operation in which a fuel oil is used as a fuel as a backup. A fuel oil supply device for supplying a fuel oil, which is a fuel for oil firing, includes, for example, a supply pressure regulation valve for regulating a supply pressure of the fuel oil from a fuel oil supply source, a flow rate regulation valve for regulating a flow rate of the fuel oil in each system for a plurality of fuel nozzles of a combustor, and a differential pressure regulation valve for regulating a differential pressure between an upstream side and a downstream side of the flow rate regulation valve. In this configuration, the flow rate regulation valve and the differential pressure regulation valve are provided for each supply system corresponding to the fuel nozzle. Therefore, since the number of regulation valves (the total number of the supply pressure regulation valve, the flow rate regulation valve, and the differential pressure regulation valve) is large as a whole, the initial cost at the time of introduction is high.

As a method for solving such a problem, it is conceivable to reduce the number of the adjustment valves by sharing the plurality of differential pressure regulation valves provided in each supply system across the supply systems in the above-described configuration. That is, by providing the pressure regulation valve shared by the supply systems on the downstream side of the supply pressure regulation valve, the number of the adjustment valves included in the fuel oil supply device can be reduced as compared to a case where the differential pressure regulation valve is provided for each supply system. For example, although PTL 1 discloses a configuration in which a fuel gas is supplied as a fuel instead of a fuel oil, a configuration example in which the number of the regulation valves is reduced by reducing the number of the differential pressure regulation valves disposed on the upstream side of the flow rate regulation valve for regulating a fuel flow rate for each fuel nozzle is disclosed.

### CITATION LIST

### Patent Literature

[PTL 1] International Publication No. WO2013/105406

### SUMMARY OF INVENTION

### Technical Problem

As described above, in a case where the number of the differential pressure regulation valves is reduced in the fuel oil supply system corresponding to each fuel nozzle, the number of pressure-reducing stages by the regulation valve in each supply system is reduced (that is, in a configuration having the differential pressure adjustment valve and the flow rate adjustment valve, two-stage pressure reduction is used, but when the number of the differential pressure regulation valves is reduced, one-stage pressure reduction is used by the flow rate adjustment valve). As a result, the differential pressure between the upstream pressure and the downstream pressure of the flow rate regulation valve increases, and there is a concern that cavitation may occur in the fuel oil passing through the flow rate adjustment valve.

At least one embodiment of the present disclosure has been made in view of the above-described circumstances, and an object of the present disclosure is to provide a fuel oil supply device capable of preventing cavitation from occurring in a flow rate regulation valve even in a case where the number of pressure-reducing stages of a fuel oil is reduced in accordance with reduction of the number of valves in a fuel oil supply system for each fuel nozzle.

### Solution to Problem

In order to solve the above-described problems, a fuel oil supply device according to at least one embodiment of the present disclosure is
a fuel oil supply device for supplying a fuel oil to a combustor of a gas turbine, the fuel oil supply device including:
a pump for supplying the fuel oil;
a supply pressure regulation valve disposed on a downstream side of the pump and for regulating a supply pressure of the fuel oil by the pump;
a plurality of flow rate regulation valves disposed on a downstream side of the supply pressure adjustment valve and for regulating a flow rate of the fuel oil supplied to a plurality of fuel nozzles included in the combustor;
a plurality of cavitation suppression units provided on a downstream side of each of the plurality of flow rate regulation valves; and
an opening degree control unit for controlling an opening degree of the flow rate adjustment valve based on a first pressure of the fuel oil on an upstream side of the flow rate regulation valve, a second pressure of the fuel oil on the downstream side of the flow rate regulation valve, and the flow rate of the fuel oil supplied to the fuel nozzle.

### Advantageous Effects of Invention

According to at least one embodiment of the present disclosure, even in a case where the number of pressure-reducing stages of a fuel oil is reduced in accordance with reduction of the number of valves in a fuel oil supply system for a fuel nozzle, it is possible to provide a fuel oil supply device capable of preventing cavitation from occurring in a flow rate regulation valve.

### BRIEF DESCRIPTION OF DRAWINGS

FIG. 1 is a schematic configuration diagram of a gas turbine power generation plant according to one embodiment.

FIG. 2 is a schematic configuration diagram of a fuel oil supply device in FIG. 1.

FIG. 3 is a schematic configuration diagram of a fuel supply device according to a comparative example in FIG. 2.

FIG. 4 is a schematic diagram showing a cross-sectional structure of a cavitation suppression unit in FIG. 2.

FIG. 5 is a block diagram showing a functional configuration of a control device of the fuel oil supply device in FIG. 2.

FIG. 6 is a diagram showing a calculation logic of a second pressure calculation unit in FIG. 5.

FIG. 7 is a diagram showing a calculation logic for calculating a cabin pressure in FIG. 6.

FIG. 8 is a graph showing a relationship between a first pressure, a second pressure, a cabin pressure, a pressure loss of the cavitation suppression unit, and a nozzle pressure loss.

### DESCRIPTION OF EMBODIMENTS

Hereinafter, some embodiments of the present invention will be described with reference to the accompanying drawings. Meanwhile, configurations described in the embodiments or shown in the drawings are not intended to limit the scope of the present invention, and are merely examples for description.

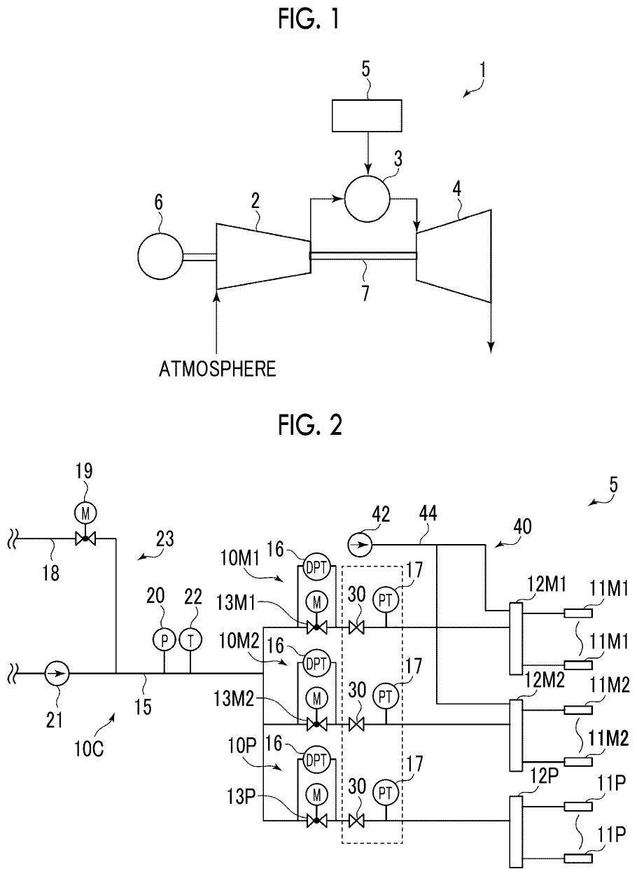

FIG. 1 is a schematic configuration diagram of a gas turbine power generation plant 1 according to one embodiment. The gas turbine power generation plant 1 includes a compressor 2, a combustor 3, a turbine 4, a fuel oil supply device 5, and a generator 6.

The compressor 2 is configured to suck air (atmosphere) from the outside to generate compressed air. The compressed air generated by the compressor 2 is supplied to the combustor 3. The combustor 3 generates high-temperature combustion gas by mixing the compressed air supplied from the compressor 2 with a fuel oil, which is a fuel supplied from the fuel oil supply device 5, and combusting the mixture. The turbine 4 receives the supply of the high-temperature gas generated by the combustor 3 and is driven to output a rotational driving force from the rotary shaft 7. The rotary shaft 7 transmits the rotational driving force output from the turbine 4 to the generator 6, and as a result, the generator 6 generates power.

Next, a specific configuration of the fuel oil supply device 5 will be described with reference to FIG. 2. FIG. 2 is a schematic configuration diagram of the fuel oil supply device 5 in FIG. 1. The fuel oil supply device 5 is configured to supply a fuel oil, which is a fuel, to the combustor 3. The combustor 3 may be configured to mainly use another fuel such as a fuel gas and to use the fuel oil supplied from the fuel oil supply device 5 as an alternative fuel.

The fuel oil supply device 5 is configured to supply the fuel oil to a fuel nozzle provided in the combustor 3. The combustor 3 may include a plurality of types of fuel nozzles. In the present embodiment, the combustor 3 includes, as the fuel nozzles, a first main nozzle 11M1 and a second main nozzle 11M2 for premixed combustion for the purpose of reducing NOx and a pilot nozzle 11P for diffusion combustion for the purpose of stabilizing combustion.

In addition to the fuel nozzles, the combustor 3 may be provided with a top hat nozzle that is a fuel nozzle for premixed combustion for the purpose of further reducing NOx. In this case, the fuel oil supply device 5 can also supply the fuel oil to the top hat nozzle. As the configuration of the combustor 3 including the top hat nozzle in this way, for example, a known configuration such as the configuration disclosed in Japanese Unexamined Patent Application Publication No. 2007-77867 can be used, and is not particularly limited.

The fuel oil supply device 5 includes a common system 10C, a first main fuel supply system 10M1, a second main fuel supply system 10M2, and a pilot fuel supply system 10P.

The common system 10C is a system for supplying the fuel oil to the first main fuel supply system 10M1, the second main fuel supply system 10M2, and the pilot fuel supply system 10P, and includes a fuel oil supply line 15. One end side of the fuel oil supply line 15 is connected to a fuel oil supply source (not shown) that is a supply source of the fuel oil, and the other end side of the fuel oil supply line 15 is branched and connected to the first main fuel supply system 10M1, the second main fuel supply system 10M2, and the pilot fuel supply system 10P. A pump 21 is provided in the fuel oil supply line 15, and by operating the pump 21, the fuel oil can be supplied from the fuel oil supply source toward the first main fuel supply system 10M1, the second main fuel supply system 10M2, and the pilot fuel supply system 10P.

A return line 18 that constitutes a return system 23 for returning at least a part of the fuel oil flowing through the fuel oil supply line 15 to the fuel oil supply source is branched from a downstream side of the pump 21 in the fuel oil supply line 15. A supply pressure regulation valve 19 is provided in the return line 18. The supply pressure adjustment valve 19 is a valve in which an opening degree can be controlled based on a control signal from the control device 50, and the pressure of the fuel oil (first pressure P1 of the fuel oil on an upstream side of the first main flow rate regulation valve 13M1, the second main flow rate regulation valve 13M2, and the pilot flow rate regulation valve 13P) supplied from the fuel oil supply line 15 to each system (the first main fuel supply system 10M1, the second main fuel supply system 10M2, and the pilot fuel supply system 10P) can be adjusted by changing the flow rate of the fuel oil to be returned to the fuel oil supply source via the return line 18 in accordance with the opening degree.

The common system 10C is provided with a pressure sensor 20 for measuring the first pressure P1 of the fuel oil in the fuel oil supply line 15 and a temperature sensor 22 for measuring the temperature T.

The first main fuel supply system 10M1 is a system for supplying a fuel oil to the first main nozzle 11M1. One end side of the first main fuel supply system 10M1 is connected to the fuel oil supply line of the common system 10C, and the other end side of the first main fuel supply system 10M1 is connected to a first main manifold 12M1 for supplying the fuel oil to each of the first main nozzles 11M1. Further, the first main fuel supply system 10M1 is provided with a first main flow rate regulation valve 13M1 for controlling the flow rate of the fuel oil supplied to the first main nozzle 11M1. The first main flow rate regulation valve 13M1 is a valve for regulating the flow rate of the fuel oil supplied to the first main nozzle 11M1. The first main manifold 12M1 is configured to distribute the fuel oil supplied from the first main fuel supply system 10M1 to the plurality of first main nozzles 11M1.

The second main fuel supply system 10M2 is a system for supplying a fuel oil to the second main nozzle 11M2. One end side of the second main fuel supply system 10M2 is connected to the fuel oil supply line 15 of the common system 10C, and the other end side of the second main fuel supply system 10M2 is connected to a second main manifold 12M2 for supplying the fuel oil to each of the second main nozzles 11M2. Further, the second main fuel supply system 10M2 is provided with a second main flow rate regulation valve 13M2 for controlling the flow rate of the fuel oil supplied to the second main nozzle 11M2. The second main flow rate regulation valve 13M2 is a valve for regulating the flow rate of the fuel oil supplied to the second main nozzle 11M2. The second main manifold 12M2 is configured to distribute the fuel oil supplied from the second main fuel supply system 10M2 to the plurality of second main nozzles 11M2.

The pilot fuel supply system 10P is a system that supplies a fuel oil to the pilot nozzle 11P. One end side of the pilot fuel supply system 10P is connected to the fuel oil supply line 15 of the common system 10C, and the other end side of the pilot fuel supply system 10P is connected to a pilot manifold 12P that supplies the fuel to the pilot nozzle 11P. Further, the pilot fuel supply system 10P is provided with a pilot flow rate regulation valve 13P that controls the flow rate of the fuel oil. The pilot flow rate regulation valve 13P is a valve that regulates the flow rate of the fuel oil supplied to the pilot nozzle 11P. The pilot manifold 12P is configured to distribute the fuel oil supplied from the pilot fuel supply system 10P to the plurality of pilot nozzles 11P.

The first main fuel supply system 10M1, the second main fuel supply system 10M2, and the pilot fuel supply system 10P each includes a differential pressure sensor 16 for detecting a differential pressure ΔP between the first pressure P1, which is an upstream pressure of the first main flow rate regulation valve 13M1, the second main flow rate regulation valve 13M2, and the pilot flow rate regulation valve 13P, and a second pressure P2, which is a downstream pressure of the first main flow rate regulation valve 13M1, the second main flow rate regulation valve 13M2, and the pilot flow rate regulation valve 13P. In addition, pressure sensors 17 for detecting the second pressure P are respectively provided on the downstream sides of the first main flow rate regulation valve 13M1, the second main flow rate regulation valve 13M2, and the pilot flow rate regulation valve 13P.

In addition, the fuel oil supply device 5 further includes a water injection device 40 for reducing NOx by injecting water into at least some of the plurality of fuel nozzles. In the present embodiment, the water injection device 40 is configured to inject water to the first main nozzle 11M1 and the second main nozzle 11M2 of the fuel nozzles of the combustor 3. Specifically, the water injection device 40 includes a water supply source 42 capable of supplying water, and a water supply line 44 connected to the first main nozzle 11M1 and the second main nozzle 11M2 from the water supply source 42.

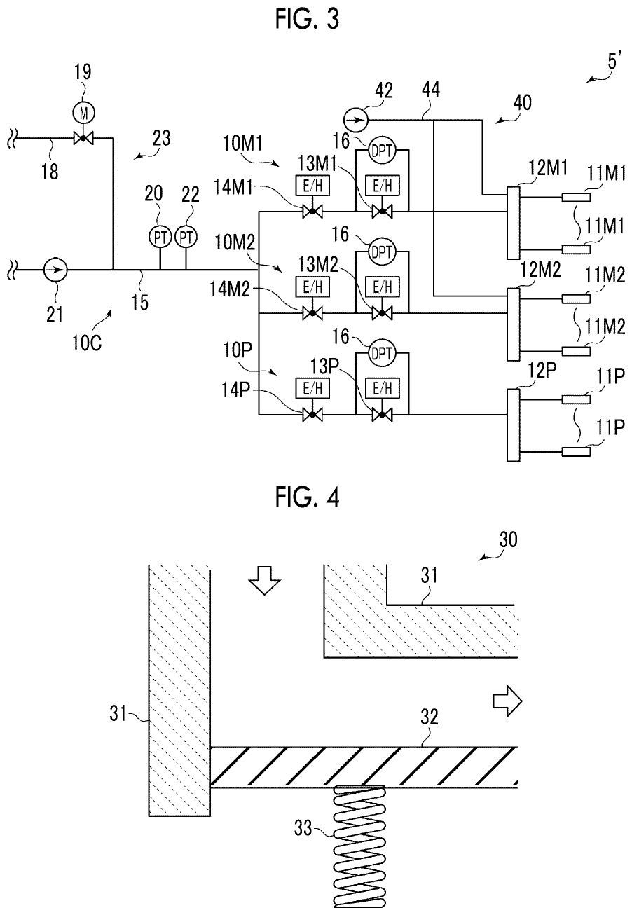

Here, FIG. 3 is a schematic configuration diagram of a fuel oil supply device 5′ according to a comparative example in FIG. 2. In the fuel oil supply device 5′, the first main differential pressure regulation valve 14M1, the second main differential pressure regulation valve 14M2, and the pilot differential pressure regulation valve 14P are respectively provided on the upstream sides of the first main flow rate regulation valve 13M1, the second main flow rate regulation valve 13M2, and the pilot flow rate regulation valve 13P in each of the first main fuel supply system 10M1, the second main fuel supply system 10M2, and the pilot fuel supply system 10P. The first main differential pressure regulation valve 14M1, the second main differential pressure regulation valve 14M2, and the pilot differential pressure regulation valve 14P are valves in which opening degree control is performed to regulate the differential pressure ΔP between the upstream pressure (first pressure P1) and the downstream pressure (second pressure P2) of each flow rate regulation valve to a predetermined value.

In the fuel oil supply device 5′ according to the comparative example shown in FIG. 3, the configuration corresponding to the fuel oil supply device 5 shown in FIG. 2 is denoted by common reference numerals, and the overlapping description will be omitted as appropriate unless otherwise specified.

In this comparative example, since the flow rate regulation valve and the differential pressure regulation valve are provided for each of the supply systems (the first main fuel supply system 10M1, the second main fuel supply system 10M2, and the pilot fuel supply system 10P) corresponding to each fuel nozzle, the number of regulation valves is large as a whole, and the initial cost at the time of introduction is high. Therefore, in the configuration of the comparative example, it is conceivable to reduce the number of adjustment valves by omitting the differential pressure regulation valve (first main differential pressure regulation valve 14M1, second main differential pressure regulation valve 14M2, and pilot differential pressure regulation valve 14P). In this case, the number of pressure-reducing stages by the regulation valve in each supply system is reduced (that is, as shown in FIG. 3, in a configuration in which each of the first main fuel supply system 10M1, the second main fuel supply system 10M2, and the pilot fuel supply system 10P is provided with the differential pressure adjustment valve and the flow rate adjustment valve, two-stage pressure reduction is used, but when the number of the differential pressure regulation valves is reduced, one-stage pressure reduction is used by the flow rate adjustment valve). As a result, there is a problem in that the differential pressure ΔP between the upstream pressure (first pressure P1) and the downstream pressure (second pressure P2) of the flow rate regulation valve increases, and cavitation is likely to occur in the fuel oil passing through the flow rate adjustment valve.

In order to solve the problem in the comparative example, in the fuel oil supply device 5 according to the present embodiment, as shown in FIG. 2, the cavitation suppression unit 30 is provided on the downstream side of each of the first main flow rate regulation valve 13M1, the second main flow rate regulation valve 13M2, and the pilot flow rate regulation valve 13P. The cavitation suppression unit 30 has, for example, a throttle structure in which a flow path cross-sectional area is variable in accordance with the flow rate of the fuel oil passing therethrough.

FIG. 4 is a schematic diagram showing a cross-sectional structure of the cavitation suppression unit 30 in FIG. 2. In this configuration example, a flow path through which the fuel oil that has passed through each flow rate regulation valve passes is configured by a fixed wall surface 31 and a movable wall surface 32 elastically supported with respect to the fixed wall surface 31. The movable wall surface 32 is elastically supported with respect to the fixed wall surface 31 by the biasing member 33 such as a spring. In this manner, in a case where the flow rate of the fuel oil is relatively low, the movable wall surface 32 approaches the flow path center side due to the elastic force applied by the biasing member 33, so that the flow path cross-sectional area is relatively small. On the other hand, in a case where the flow rate of the fuel oil is relatively high, the movable wall surface 32 moves to approach the outer side from the center of the flow path by resisting the elastic force applied by the biasing member 33 with respect to the pressure received from the fuel oil, and the flow path cross-sectional area increases. Therefore, the fuel oil supply device 5 according to the present embodiment includes the cavitation suppression unit 30 described above, thereby the flow path cross-sectional area is made variable by the flow rate of the fuel oil passing through each flow rate regulation valve (first main flow rate regulation valve 13M1, second main flow rate regulation valve 13M2, and pilot flow rate regulation valve 13P). In this manner, even in a case where the differential pressure between the first pressure P1 on the upstream side and the second pressure P2 on the downstream side of each flow rate regulation valve is large, cavitation can be effectively suppressed.

Each cavitation suppression unit 30 may be integrally configured with the first main flow rate regulation valve 13M1, the second main flow rate regulation valve 13M2, and the pilot flow rate regulation valve 13P. In this case, the above-described configuration can be realized in a compact aspect by integrally configuring the cavitation suppression unit 30 with each flow rate regulation valve.

Next, a configuration of the control device 50 for controlling the fuel oil supply device 5 having the above configuration will be described.

For example, the control device 50 is configured to include a central processing unit (CPU), a random access memory (RAM), a read only memory (ROM), and a computer-readable storage medium. A series of processing for realizing various functions is stored in a storage medium or the like in the form of a program, as an example, and the CPU reads out the program to the RAM or the like, and executes processing for information processing and calculation, whereby various functions are realized. A form installed in advance in the ROM or other storage medium, a form provided in a state of being stored in a computer-readable storage medium, or a form of being delivered via wired or wireless communication means may be applied as the program. The computer-readable storage medium is a magnetic disk, a magneto-optical disk, a CD-ROM, a DVD-ROM, a semiconductor memory, or the like.

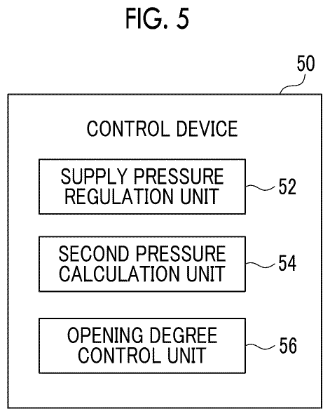

FIG. 5 is a block diagram showing a functional configuration of the control device 50 of the fuel oil supply device in FIG. 2. The control device 50 includes a supply pressure regulation unit 52, a second pressure calculation unit 54, and an opening degree control unit 56.

The supply pressure regulation unit 52 is configured to regulate the supply pressure of the fuel oil by the common system 10C. Specifically, the supply pressure regulation unit 52 controls the supply pressure of the fuel oil by the pump 21 and the opening degree of the supply pressure regulation valve 19 such that the first pressure P1 detected by the pressure sensor 20 is set to a predetermined value. In this manner, the supply pressure (substantially equal to the first pressure P1) by the common system 10C is adjusted such that the supply pressure is set to the predetermined value.

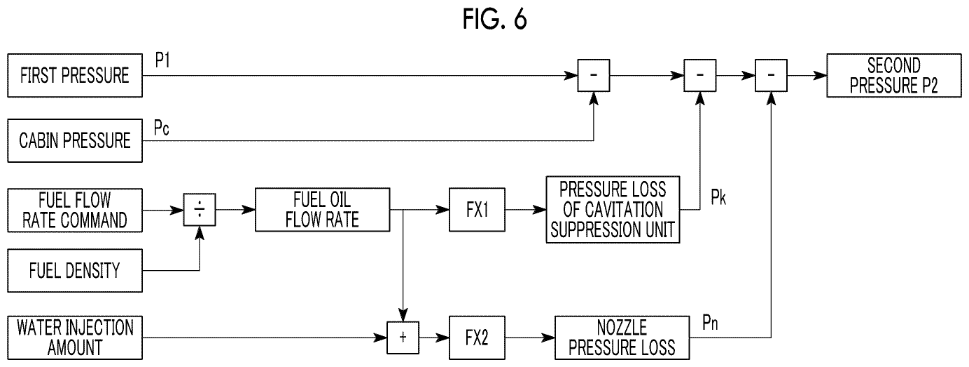

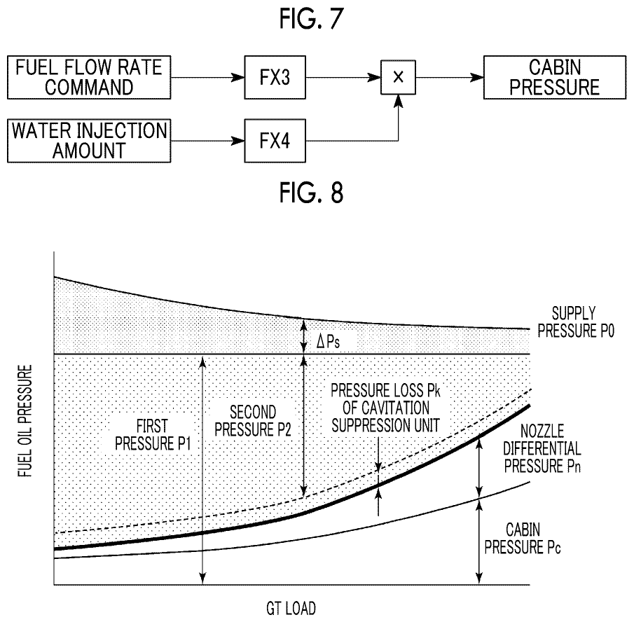

The second pressure calculation unit 54 is configured to calculate the second pressure P2, which is the downstream pressure of each flow rate regulation valve (the first main flow rate regulation valve 13M1, the second main flow rate regulation valve 13M2, and the pilot flow rate regulation valve 13P). Here, FIG. 6 is a diagram showing a calculation logic of the second pressure calculation unit 54 in FIG. 5, FIG. 7 is a diagram showing a calculation logic for calculating a cabin pressure Pc in FIG. 6, and FIG. 8 is a graph showing a relationship between the first pressure P1, the second pressure P2, the cabin pressure Pc, a pressure loss Pk of the cavitation suppression unit 30, and a nozzle pressure loss Pn.

As shown in FIG. 6, the second pressure P2, which is the downstream pressure of each flow rate regulation valve (the first main flow rate regulation valve 13M1, the second main flow rate regulation valve 13M2, and the pilot flow rate regulation valve 13P), is calculated by respectively subtracting the cabin pressure Pc, the pressure loss Pk of the cavitation suppression unit 30, and the nozzle pressure loss Pn from the first pressure P1, which is the upstream pressure. Here, the first pressure P1 is adjusted by controlling the pump 21 and the supply pressure regulation valve 19 such that the detection value of the pressure sensor 20 is set to a predetermined value by the supply pressure regulation unit 52 as described above (FIG. 8 shows that the first pressure P1 is obtained by subtracting the differential pressure ΔPs of the supply pressure regulation valve 19 from a supply pressure P0 by the pump 21).

In addition, as shown in FIG. 7, for example, the cabin pressure Pc is obtained by multiplying a result of inputting a fuel flow rate command calculated based on a supply and demand signal for the gas turbine power generation plant 1 to a function FX3 and a result of inputting the water injection amount by the water injection device 40 to a function FX4.

In addition, as shown in FIG. 6, the pressure loss Pk of the cavitation suppression unit 30 is obtained as a result of inputting the fuel oil flow rate to a function FX1. The function FX1 is prepared in advance as a function that defines a correlation between the fuel oil flow rate and the pressure loss Pk of the cavitation suppression unit 30. The fuel oil flow rate is obtained by dividing the fuel flow rate command by the fuel density.

In addition, the nozzle pressure loss Pn is obtained by inputting a result of adding the above-described fuel oil flow rate and the water injection amount by the water injection device 40 to the function FX2. The function FX2 is prepared in advance as a function that defines a correlation between the addition result of the fuel oil flow rate and the water injection amount and the nozzle pressure loss Pn.

The cabin pressure Pc, the pressure loss Pk of the cavitation suppression unit 30, and the nozzle pressure loss Pn obtained in this way are respectively subtracted from the first pressure P1, which is the upstream pressure of each flow rate regulation valve. In this manner, the second pressure P2, which is the downstream pressure of each flow rate regulation valve, is obtained.

Returning to FIG. 5, the opening degree control unit 56 is configured to control the opening degree of each flow rate regulation valve (the first main flow rate regulation valve 13M1, the second main flow rate regulation valve 13M2, and the pilot flow rate regulation valve 13P). The opening degree of each flow rate regulation valve is calculated based on the first pressure P1 of the fuel oil on the upstream side of the flow rate regulation valve, the second pressure P2 on the downstream side of the flow rate regulation valve, and the flow rate of the fuel oil supplied to each fuel nozzle. As described above, the first pressure P1 is unambiguously determined by the supply pressure regulation unit 52 regulating the detection value of the pressure sensor 20 to a predetermined value. The second pressure P2 is calculated using the calculation result of the second pressure calculation unit 54 described above.

In this way, the opening degree control unit 56 performs the opening degree control of each flow rate regulation valve (the first main flow rate regulation valve 13M1, the second main flow rate regulation valve 13M2, and the pilot flow rate regulation valve 13P) based on the second pressure P2, but the second pressure P2 calculated in consideration of the pressure loss Pk of the cavitation suppression unit 30 is used. Accordingly, even in a case where the cavitation suppression unit 30 is provided on the downstream side of each flow rate regulation valve to suppress cavitation, the opening degree control of each flow rate regulation valve can be performed based on the second pressure P2 with high accuracy.

In addition, as described above, the second pressure P2 used for the opening degree control of each flow rate regulation valve is calculated based on the cabin pressure Pc and the nozzle pressure loss Pn obtained in consideration of the water injection amount by the water injection device 40. Accordingly, in the fuel oil supply device 5 including the water injection device 40, the opening degree control of each flow rate adjustment valve can be performed with high accuracy by obtaining the cabin pressure Pc and the nozzle pressure loss Pn in consideration of the influence of the water injection.

As described above, according to the above embodiment, even in a case where the number of pressure-reducing stages of the fuel oil is reduced in accordance with reduction of the number of valves in a fuel oil supply system for a fuel nozzle, it is possible to provide the fuel oil supply device 5 capable of preventing cavitation from occurring in each flow rate regulation valve.

In addition, it is possible to appropriately replace the components in the embodiment described above with well-known components within the scope which does not depart from the gist of the present disclosure, and the embodiments described above may be combined appropriately.

For example, contents described in each of the above-described embodiments are understood as follows.

(1) A fuel oil supply device according to one aspect is
a fuel oil supply device for supplying a fuel oil to a combustor of a gas turbine, the fuel oil supply device including:
a pump for supplying the fuel oil;
a supply pressure regulation valve disposed on a downstream side of the pump and for regulating a supply pressure of the fuel oil by the pump;
a plurality of flow rate regulation valves disposed on a downstream side of the supply pressure adjustment valve and for regulating a flow rate of the fuel oil supplied to a plurality of fuel nozzles included in the combustor;
a plurality of cavitation suppression units provided on a downstream side of each of the plurality of flow rate regulation valves; and
an opening degree control unit for controlling an opening degree of the flow rate adjustment valve based on a first pressure of the fuel oil on an upstream side of the flow rate regulation valve, a second pressure of the fuel oil on the downstream side of the flow rate regulation valve, and the flow rate of the fuel oil supplied to the fuel nozzle.

According to the aspect of the above (1), the cavitation suppression unit is provided on the downstream side of the flow rate regulation valve provided for each supply system for supplying the fuel oil to each fuel nozzle of the combustor. Accordingly, even in a case where the differential pressure in the upstream side and the downstream side of the flow rate regulation valve increases due to the reduction of the number of the differential pressure regulation valves in each supply system, it is possible to effectively prevent the occurrence of cavitation in the fuel oil that has passed through the flow rate regulation valve.

(2) In another aspect according to the aspect of the above (1),
the second pressure includes a pressure loss of the cavitation suppression unit calculated based on the flow rate of the fuel oil.

According to the aspect of the above (2), the pressure loss in the cavitation suppression unit is included in the second pressure used for the opening degree control of the flow rate regulation valve. By performing the opening degree control of the flow rate regulation valve in consideration of the influence of providing the cavitation suppression unit on the downstream side of the flow rate regulation valve in this way, it is possible to perform the flow rate control of the fuel oil supplied to each fuel nozzle with high accuracy while preventing the occurrence of cavitation.

(3) In still another aspect according to the aspect of the above (2),
the second pressure further includes
   a cabin pressure of the gas turbine calculated based on the flow rate of the fuel oil, and
   a nozzle pressure loss caused by the plurality of fuel nozzles.

According to the aspect of the above (3), the second pressure (downstream pressure of the flow rate regulation valve) used for the opening degree control of the flow rate regulation valve can be accurately obtained by considering the cabin pressure of the gas turbine and the nozzle pressure loss together with the pressure loss of the cavitation suppression unit described above.

(4) In still another aspect according to the aspect of the above (3), the fuel oil supply device further includes:
a water injection device for injecting water into at least some of the plurality of fuel nozzles, wherein
the cabin pressure is corrected based on an injection amount of the water by the water injection device, and
the nozzle pressure loss is calculated based on the injection amount of the water and the flow rate of the fuel oil.

According to the aspect of the above (4), in a case where the water injection device for reducing NOx discharged from the gas turbine by performing the water injection on at least some of the fuel nozzles is provided, the cabin pressure and the nozzle pressure loss used for calculating the second pressure are calculated based on the injection amount of water by the water injection device. Accordingly, by considering the influence of the water injection on the cabin pressure and the nozzle pressure loss, it is possible to perform the opening degree control of the flow rate adjustment valve with high accuracy even in a device including the water injection device.

(5) In still another aspect according to any one aspect of the above (1) to (4),
the pump is provided in a fuel oil supply line connected to a fuel oil supply source, and
the supply pressure regulation valve is provided in a return line that branches from a downstream side of the pump and the upstream side of the flow rate adjustment valve in the fuel oil supply line and that returns at least some of the fuel oil supplied by the pump to the fuel oil supply source.

According to the aspect of the above (5), the return line for returning some of the fuel oil to the fuel oil supply source is provided from between the pump and the flow rate regulation valve in the fuel oil supply line connected to the fuel oil supply source. The return line is provided with a supply pressure regulation valve, and the first pressure, which is the supply pressure of the fuel oil from the pump, can be controlled by regulating the opening degree of the supply pressure regulation valve.

(6) In still another aspect according to any one aspect of the above (1) to (5),
an opening degree of the supply pressure regulation valve is controlled such that the first pressure is constant.

According to the aspect of the above (6), the first pressure can be maintained constant by the opening degree control of the supply pressure regulation valve.

(7) In still another aspect according to any one aspect of the above (1) to (6),
the cavitation suppression unit is integrally configured with the flow rate adjustment valve.

According to the aspect of the above (7), the above-described configuration can be realized in a compact aspect by integrally configuring the cavitation suppression unit with the flow rate regulation valve.

(8) In still another aspect according to any one aspect of the above (1) to (7),
the cavitation suppression unit has a throttle structure in which a flow path cross-sectional area is variable in accordance with the flow rate of the fuel oil.

According to the aspect of the above (8), by providing the throttle structure in which the flow path cross-sectional area is variable in accordance with the flow rate of the fuel oil on the downstream side of the flow rate regulation valve, it is possible to suitably realize the cavitation suppression unit that can effectively suppress cavitation even in a case where the differential pressure on the upstream side and the downstream side of the flow rate regulation valve is large.

### REFERENCE SIGNS LIST

1: gas turbine power generation plant
2: compressor
3: combustor
4: turbine
5: fuel oil supply device
6: generator
7: rotary shaft
10C: common system
10M1: first main fuel supply system
10M2: second main fuel supply system
10P: pilot fuel supply system
11M1: first main nozzle
11M2: second main nozzle
11P: pilot nozzle
12M1: first main manifold
12M2: second main manifold
12P: pilot manifold
13M1: first main flow rate regulation valve
13M2: second main flow rate regulation valve
13P: pilot flow rate regulation valve
14M1: first main differential pressure regulation valve
14M2: second main differential pressure regulation valve
14P: pilot differential pressure regulation valve
15: fuel oil supply line
16: differential pressure sensor
17: pressure sensor
18: return line
19: supply pressure regulation valve
20: pressure sensor
21: pump
22: temperature sensor
23: return system
30: cavitation suppression unit
31: fixed wall surface
32: movable wall surface
33: biasing member
40: water injection device
42: water supply source
44: water supply line
50: control device
52: supply pressure regulation unit

1. A fuel oil supply device for supplying a fuel oil to a combustor of a gas turbine, the fuel oil supply device comprising:
a pump for supplying the fuel oil;
a supply pressure regulation valve disposed on a downstream side of the pump and for regulating a supply pressure of the fuel oil by the pump;
a plurality of flow rate regulation valves disposed on a downstream side of the supply pressure adjustment valve and for regulating a flow rate of the fuel oil supplied to a plurality of fuel nozzles included in the combustor;
a plurality of cavitation suppression units provided on a downstream side of each of the plurality of flow rate regulation valves; and
an opening degree control unit for controlling an opening degree of the flow rate adjustment valve based on a first pressure of the fuel oil on an upstream side of the flow rate regulation valve, a second pressure of the fuel oil on the downstream side of the flow rate regulation valve, and the flow rate of the fuel oil supplied to the fuel nozzle.

2. The fuel oil supply device according to claim 1, wherein
the second pressure includes a pressure loss of the cavitation suppression unit calculated based on the flow rate of the fuel oil.

3. The fuel oil supply device according to claim 2, wherein
the second pressure further includes
a cabin pressure of the gas turbine calculated based on the flow rate of the fuel oil, and
a nozzle pressure loss caused by the plurality of fuel nozzles.

4. The fuel oil supply device according to claim 3, further comprising:
a water injection device for injecting water into at least some of the plurality of fuel nozzles, wherein
the cabin pressure is corrected based on an injection amount of the water by the water injection device, and
the nozzle pressure loss is calculated based on the injection amount of the water and the flow rate of the fuel oil.

5. The fuel oil supply device according to claim 1, wherein
the pump is provided in a fuel oil supply line connected to a fuel oil supply source, and
the supply pressure regulation valve is provided in a return line that branches from a downstream side of the pump and the upstream side of the flow rate adjustment valve in the fuel oil supply line and that returns at least some of the fuel oil supplied by the pump to the fuel oil supply source.

6. The fuel oil supply device according to claim 1, wherein
an opening degree of the supply pressure regulation valve is controlled such that the first pressure is constant.

7. The fuel oil supply device according to claim 1, wherein
the cavitation suppression unit is integrally configured with the flow rate adjustment valve.

8. The fuel oil supply device according to claim 1, wherein
the cavitation suppression unit has a throttle structure in which a flow path cross-sectional area is variable in accordance with the flow rate of the fuel oil.
